(19) United States
(12) Patent Application Publication
(10) Pub. No.: US 2026/0225386 A1
(43) Pub. Date: Aug. 6, 2026

(54) IMAGE FORMING DEVICE

(71) Applicant: RISO KAGAKU CORPORATION, Tokyo (JP)

(72) Inventor: Asayo NISHIMURA, Tokyo (JP)

(73) Assignee: RISO KAGAKU CORPORATION, Tokyo (JP)

(21) Appl. No.: 19/448,834

(22) Filed: Jan. 14, 2026

(30) Foreign Application Priority Data
Feb. 6, 2025 (JP) 2025-017984

(51) Int. Cl. B41J 29/377; B41J 2/045; B41J 11/00

(52) U.S. Cl. CPC B41J 29/377; B41J 2/04515; B41J 2/04563; B41J 11/007; B41J 11/0085; B41J 2/04586

(57) ABSTRACT

An image forming device includes: a conveyance unit that holds and conveys an image forming medium on a conveyance surface; and an image forming unit that forms an image on the image forming medium conveyed by the conveyance unit, in which the image forming unit includes a plurality of head rows in each of which a plurality of image forming heads are arranged at intervals in a head arrangement direction perpendicular to a conveyance direction in which the image forming medium is conveyed by the conveyance unit, the plurality of head rows being provided at positions different in the conveyance direction, and air blowing units that are arranged between at least some of the plurality of image forming heads in the head arrangement direction in at least some of the plurality of head rows and blow air in the head arrangement direction.

### CROSS-REFERENCE TO RELATED APPLICATION

This application is based upon and claims the benefit of priority of the prior Japanese Patent Application No. 2025-017984 filed on February 6, 2025, the entire contents of which are incorporated herein by reference.

### FIELD

Embodiments discussed herein are related to an image forming device.

### BACKGROUND

An inkjet type image forming device that ejects ink from an inkjet head to form an image on an image forming medium such as a sheet is widely used. This type of image forming device includes a cooling unit for cooling an inkjet head that generates heat during operation, and for example, an air-cooling type cooling unit that performs air blowing by rotation of a cooling fan to remove heat from the inkjet head is known.

In the case of an image forming unit in which a plurality of inkjet heads are arranged side by side in a direction (width direction of the image forming medium) orthogonal to the conveyance direction of the image forming medium, the cooling air supplied to the inkjet head arranged at a position far from the cooling fan is weak, and the cooling performance may be insufficient.

In order to solve such a problem, for example, in the inkjet printing apparatus disclosed in Japanese Patent Laid-Open Publication No. 2015-039836, in the air-cooling type cooling unit, the plurality of air supply fans are controlled so that the airflow flows in from some of the plurality of inflow ports, and the plurality of exhaust fans are controlled so that the airflow flows out from some of the plurality of outflow ports, thereby efficiently cooling some inkjet heads whose temperature has increased.

Further, in the image recording apparatus disclosed in Japanese Patent Laid-Open Publication No. 2007-090835, the air flowing into the periphery of the recording head of the image recording unit is sucked by the suction unit included in the conveyance mechanism that conveys the image forming medium, thereby forming an airflow for cooling the recording head.

In the method of Japanese Patent Laid-Open Publication No. 2015-039836, there are problems that the control of the air supply fan and the exhaust fan for uniformly cooling the plurality of inkjet heads is complicated, and the cooling effect is limited because the airflow does not pass through some inflow ports and outflow ports. In the method of Japanese Patent Laid-Open Publication No. 2007-090835, the air around the recording head can be sucked to the conveyance mechanism side to perform cooling only at the timing during the conveyance of the plurality of image forming media, and particularly in recent years, since the conveyance and printing of the image forming media have become faster, the timing is very short, and there is a problem that it is difficult to realize a high cooling effect.

As described above, in the conventional image forming device, when a plurality of image forming heads such as inkjet heads are provided, it has been desired that temperature adjustment of the plurality of image forming heads can be efficiently performed by simple control.

### SUMMARY

According to one aspect, there is provided an image forming device including: a conveyance unit that holds and conveys an image forming medium on a conveyance surface; and an image forming unit that forms an image on the image forming medium conveyed by the conveyance unit, in which the image forming unit includes a plurality of head rows in each of which a plurality of image forming heads are arranged at intervals in a head arrangement direction perpendicular to a conveyance direction in which the image forming medium is conveyed by the conveyance unit, the plurality of head rows being provided at positions different in the conveyance direction, and air blowing units that are arranged between at least some of the plurality of image forming heads in the head arrangement direction in at least some of the plurality of head rows and blow air in the head arrangement direction.

An object and advantages of the invention will be realized and attained by means of the elements and combinations particularly pointed out in the claims.

### BRIEF DESCRIPTION OF THE DRAWINGS

FIG. 1 is a cross-sectional view illustrating an image forming unit and an under-head conveyance unit included in an image forming device;

FIG. 2 is a cross-sectional view illustrating an internal structure of the image forming unit taken along line II-II in FIG. 1;

FIG. 3 is a top view of a conveyance belt constituting the under-head conveyance unit;

FIG. 4 is a perspective view for explaining an operation when the image forming head is cooled by the image forming unit;

FIG. 5 is a perspective view for explaining an operation when the image forming head is heated by the image forming unit;

FIG. 6 is a block diagram illustrating a control system of the image forming device; and

FIG. 7 is a cross-sectional view illustrating an internal structure of an image forming unit of a comparative example.

### DETAILED DESCRIPTION

Hereinafter, an image forming device of the present disclosure will be described with reference to the illustrated embodiment. The X-axis direction, the Y-axis direction, and the Z-axis direction illustrated in each drawing are directions perpendicular to each other. The Z-axis direction is a vertical direction of the image forming device, and the +Z direction side is an upper side and the -Z direction side is a lower side.

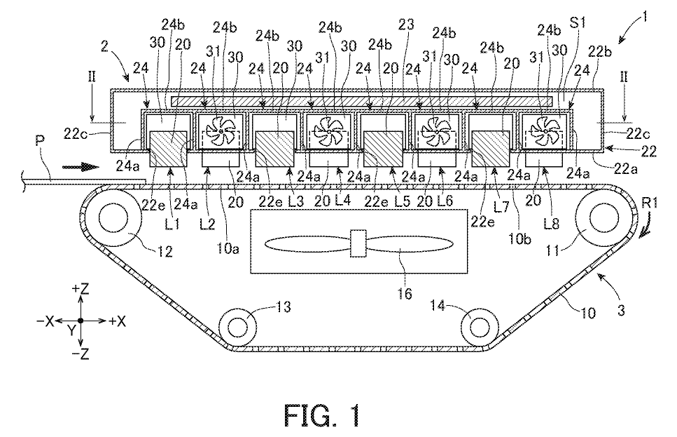

An image forming device 1 illustrated in FIG. 1 includes an image forming unit 2 and an under-head conveyance unit 3 that is a conveyance unit disposed below the image forming unit 2. The operation of each part of the image forming device 1 including the image forming unit 2 and the under-head conveyance unit 3 is controlled by a control unit 4 illustrated in FIG. 6.

The image forming device 1 is a device that forms an image by an inkjet printing method in which ink is ejected from an image forming head, and the image forming unit 2 includes a plurality of inkjet heads 20 as a plurality of image forming heads. The image forming device 1 forms an image on a sheet P by conveying the sheet P, which is an image forming medium, at a predetermined speed by the under-head conveyance unit 3 and discharging ink onto the sheet P from the plurality of inkjet heads 20 of the image forming unit 2. The image forming device 1 includes a sheet feeding unit and a sheet ejection unit (not illustrated). The sheet P before image formation is conveyed from the sheet feeding unit to the under-head conveyance unit 3, and the sheet P after image formation is ejected by the sheet ejection unit.

The under-head conveyance unit 3 conveys the sheet P in the X-axis direction which is the conveyance direction. The Y-axis direction is a width direction of the sheet P conveyed by the under-head conveyance unit 3. When an image is formed on the sheet P in the image forming device 1, the sheet P is conveyed by the under-head conveyance unit 3 from the -X direction side, which is the upstream in the conveyance direction, toward the +X direction side, which is the downstream in the conveyance direction.

As illustrated in FIG. 1, the under-head conveyance unit 3 includes a conveyance belt 10, a driving pulley 11, and a plurality of (three) driven pulleys 12, 13, and 14. The conveyance belt 10 is a belt-like body having a loop shape (endless shape) wound around the driving pulley 11 and the plurality of driven pulleys 12, 13, and 14. The conveyance belt 10 wound around the pulleys 11, 12, 13, and 14 forms a substantially horizontal conveyance surface 10a between the driving pulley 11 and the driven pulley 12, and the sheet P is placed on the conveyance surface 10a. The driving pulley 11 is rotationally driven by a conveyance motor 15 (FIG. 6) controlled by the control unit 4.

In the conveyance belt 10, a plurality of suction holes 10b penetrating in the thickness direction are formed at predetermined intervals in the X-axis direction and the Y-axis direction. As illustrated in FIG. 1, the under-head conveyance unit 3 includes a suction fan 16 below the conveyance surface 10a between the driving pulley 11 and the driven pulley 12. The suction fan 16 is rotationally driven by a suction fan drive motor 17 (FIG. 6) controlled by the control unit 4, and an airflow from the upper side to the lower side in the Z-axis direction is generated by the rotation of the suction fan 16. Therefore, when the suction fan 16 is rotated, the air is sucked from the upper side to the lower side of the conveyance surface 10a through the plurality of suction holes 10b, and a negative pressure that suctions the sheet P onto the conveyance surface 10a acts. As described above, the suction fan 16 and the plurality of suction holes 10b constitute a suction unit that generates a suction force for suctioning and holding the sheet P on the conveyance surface 10a.

When the sheet P is conveyed by the under-head conveyance unit 3, the control unit 4 rotates the driving pulley 11 by driving the conveyance motor 15 while driving the suction fan drive motor 17 so that the sheet P is suctioned and held on the conveyance surface 10a by the suction force generated by the rotation of the suction fan 16. When the driving pulley 11 rotates, a driving force is transmitted to the conveyance belt 10, and the conveyance belt 10 circulates between the pulleys 11, 12, 13, and 14 while being guided by the driven pulleys 12, 13, and 14 to move the sheet P suctioned and held on the conveyance surface 10a in the X-axis direction. More specifically, by rotating the driving pulley 11 in the direction of the arrow R1 in FIG. 1, the sheet P moves from the upstream in the conveyance direction (-X direction side) to the downstream in the conveyance direction (+X direction side).

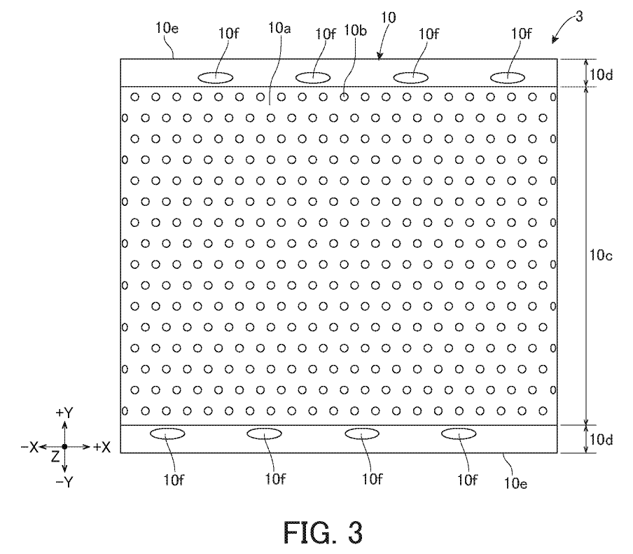

As illustrated in FIGS. 3 to 5, the conveyance belt 10 includes a conveyance function unit 10c in which a plurality of suction holes 10b are formed, and a pair of side regions 10d arranged on both sides in the width direction (Y-axis direction) of the conveyance belt 10 with respect to the conveyance function unit 10c. Each side region 10d extends from the conveyance function unit 10c to a side end 10e of the conveyance belt 10 in the width direction, and the suction hole 10b for sheet suction is not formed in the side region 10d. In FIGS. 3 to 5, the boundary between the conveyance function unit 10c and the side region 10d is indicated by a solid line, but there may be no apparent boundary such as a line between the conveyance function unit 10c and the side region 10d. That is, the conveyance function unit 10c and the side region 10d may be distinguished only by the presence or absence of the suction hole 10b.

The width of the conveyance function unit 10c in the Y-axis direction has a size that covers the maximum width of the sheet P to be conveyed and image-formed by the image forming device 1, and all the sheets P are conveyed while passing within the width range of the conveyance function unit 10c.

In each of the pair of side regions 10d of the conveyance belt 10, a plurality of outer suction holes 10f are formed at predetermined intervals in the X-axis direction which is the conveyance direction. The role and arrangement of the outer suction holes 10f will be described later.

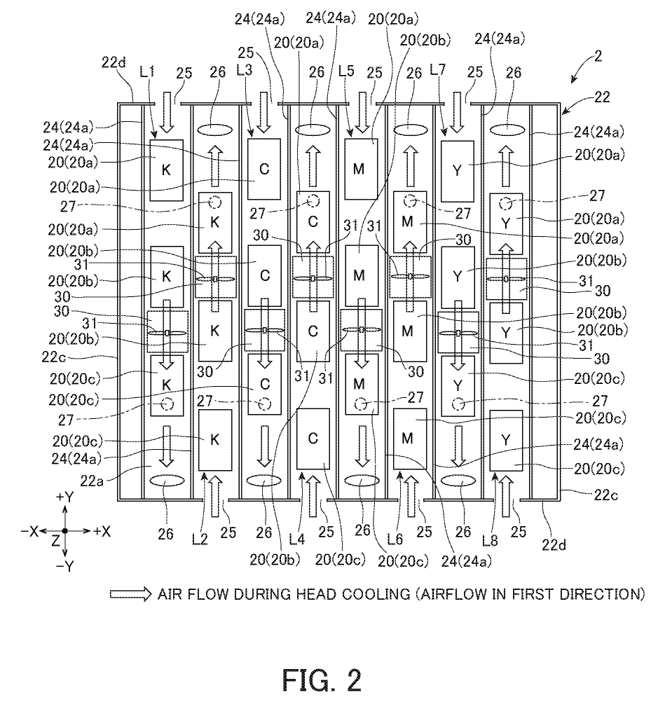

The image forming unit 2 disposed above the under-head conveyance unit 3 includes a plurality of inkjet heads 20 and a head holder 22 that holds the plurality of inkjet heads 20 therein. The image forming unit 2 of the present embodiment constitutes a line-type inkjet printing unit, and as illustrated in FIG. 2, a plurality of (eight) head rows including a plurality of (three) inkjet heads 20 arranged at predetermined intervals in the Y-axis direction (main scanning direction), which is the head arrangement direction, are arranged in the X-axis direction (sub-scanning direction). That is, the image forming unit 2 includes eight head rows L1, L2, L3, L4, L5, L6, L7, and L8, and each head row includes three inkjet heads 20 arranged at intervals in the head arrangement direction. In the two head rows adjacent to each other in the X-axis direction, the three inkjet heads 20 are arranged so as to be displaced from each other in the Y-axis direction, and in the entire image forming unit 2, a plurality of (24) inkjet heads 20 are arranged in a staggered pattern in a top view.

Each of the inkjet heads 20 of the two head rows L1 and L2 adjacent in the X-axis direction is connected to an ink supply path (not illustrated) for supplying the black (K) ink, and by performing control of heating to a predetermined temperature by a head control unit 21 (FIG. 6) of the control unit 4, the black (K) ink can be selectively ejected from a plurality of nozzles facing downward (-Z direction side). Each of the inkjet heads 20 of the two head rows L3 and L4 adjacent in the X-axis direction is connected to an ink supply path (not illustrated) for supplying the cyan (C) ink, and by performing control of heating to a predetermined temperature by the head control unit 21 of the control unit 4, the cyan (C) ink can be selectively ejected from a plurality of nozzles facing downward (-Z direction side). Each of the inkjet heads 20 of the two head rows L5 and L6 adjacent in the X-axis direction is connected to an ink supply path (not illustrated) for supplying the magenta (M) ink, and by performing control of heating to a predetermined temperature by the head control unit 21 of the control unit 4, the magenta (M) ink can be selectively ejected from a plurality of nozzles facing downward (-Z direction side). Each of the inkjet heads 20 of the two head rows L7 and L8 adjacent in the X-axis direction is connected to an ink supply path (not illustrated) for supplying the yellow (Y) ink, and by performing control of heating to a predetermined temperature by the head control unit 21 of the control unit 4, the yellow (Y) ink can be selectively ejected from a plurality of nozzles facing downward (-Z direction side). In each color of black (K), cyan (C), magenta (M), and yellow (Y), a total of six inkjet heads 20 constituting two rows of head rows are arranged to cover the range of the conveyance function unit 10c of the conveyance belt 10 in the Y-axis direction and eject ink.

The temperature of each inkjet head 20 is detected by a head temperature detection sensor 28 (FIG. 6), and temperature information of each inkjet head 20 is transmitted from the head temperature detection sensor 28 to the control unit 4.

The image forming unit 2 of the present embodiment can perform full-color printing using a combination of four color inks, but the configuration of the image forming unit of the present disclosure is not limited thereto. For example, the image forming unit may be a monochromatic printing image forming unit that includes only two head rows L1 and L2 and uses only the black (K) ink. Alternatively, the image forming unit may be an image forming unit that supports printing using inks of two or three colors or printing using inks of five or more colors. Furthermore, in the image forming unit of the present disclosure, the number of image forming heads (inkjet heads) constituting each head row is not limited to three, and one head row may include at least two image forming heads.

Each of the inkjet heads 20 has a box-shaped schematic shape whose longitudinal direction is oriented in the Y-axis direction, and has an ink ejection surface facing the conveyance surface 10a of the conveyance belt 10 on the lower surface side. A nozzle row including a plurality of nozzles arranged in the Y-axis direction is provided on the ink ejection surface, and the ink supplied from the ink supply path to each inkjet head 20 is ejected downward from each nozzle of the nozzle row.

The head holder 22 includes a box-shaped housing having a hollow inside, and a substantially horizontal head holding plate 22a facing the conveyance surface 10a of the conveyance belt 10 is provided on the lower surface side of the housing of the head holder 22. The housing of the head holder 22 further includes a top plate 22b positioned above the head holding plate 22a, a pair of side plates 22c connecting the head holding plate 22a and the top plate 22b on both sides in the X-axis direction, and a pair of side plates 22d connecting the head holding plate 22a and the top plate 22b on both sides in the Y-axis direction.

As illustrated in FIG. 1, a head holding opening 22e penetrating in the Z-axis direction is formed in the head holding plate 22a. The head holding openings 22e equal in number to the plurality of inkjet heads 20 are provided, and each inkjet head 20 is inserted into the head holding opening 22e and fixed to the head holding plate 22a. In each of the inkjet heads 20 fixed to the head holding plate 22a, a part including the ink ejection surface is located below the head holding plate 22a (on the conveyance surface 10a side), and the other part is located in the internal space of the head holder 22 above the head holding plate 22a.

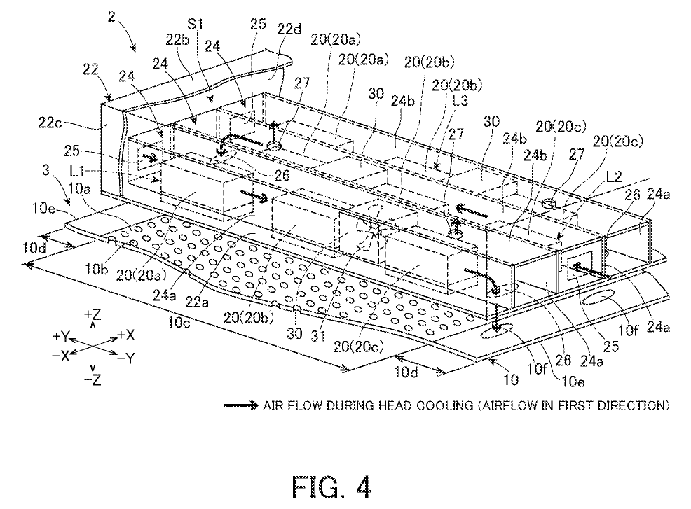

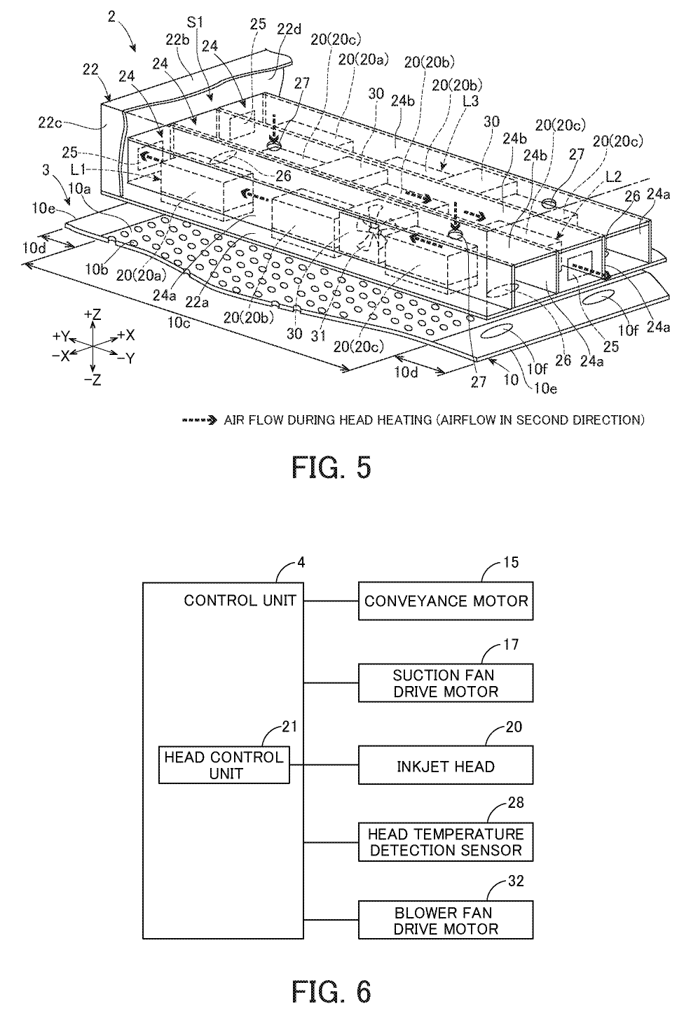

As illustrated in FIG. 1, a control board 23 that controls each unit of the image forming unit 2 including the inkjet head 20 is provided in the housing of the head holder 22. The control board 23 is disposed in an upper space S1 above the plurality of inkjet heads 20. In FIGS. 4 and 5, the control board 23 is not illustrated for the purpose of easily viewing the internal structure of the head holder 22. At least electronic components constituting the head control unit 21 (FIG. 6), which is a functional block that controls the operation of each inkjet head 20, are mounted on the control board 23. Electronic components other than the head control unit 21 may be mounted on the control board 23. In the upper space S1, electric components other than the control board 23 may be disposed.

The plurality of inkjet heads 20 and the control board 23 included in the image forming unit 2 are heating elements that generate heat during operation. Furthermore, each inkjet head 20 needs to be heated to a predetermined temperature at the time of operation. The image forming device 1 includes a temperature adjustment unit for adjusting the temperatures of the plurality of inkjet heads 20 and the control board 23. The temperature adjustment unit included in the image forming device 1 is an air-cooling type that supplies air at the time of cooling the heating element, and the detailed structure and operation thereof will be described below.

Although only the three head rows L1, L2, and L3 are illustrated in FIGS. 4 and 5, the head rows L5 and L7 not illustrated in FIGS. 4 and 5 have the same configuration as the head rows L1 and L3 illustrated in FIGS. 4 and 5, and the head rows L4, L6, and L8 not illustrated in FIGS. 4 and 5 have the same configuration as the head row L2 illustrated in FIGS. 4 and 5.

A plurality of rectangular tube-shaped ducts 24 extending along the head arrangement direction (Y-axis direction) of each of the head rows L1, L2, L3, L4, L5, L6, L7, and L8 are provided inside the head holder 22. Each of the ducts 24 forms a flow path extending in the head arrangement direction (Y-axis direction) surrounding the three inkjet heads 20 constituting each head row L1, L2, L3, L4, L5, L6, L7, and L8, and both ends in the Y-axis direction of each duct 24 are connected to the pair of side plates 22d of the head holder 22. Each of the ducts 24 has a pair of side walls 24a located on both sides in the X-axis direction of each of the inkjet heads 20, and an upper wall 24b located above each of the inkjet heads 20. A lower portion of each duct 24 is closed by the head holding plate 22a. A space above the upper wall 24b of each duct 24 is the upper space S1 for accommodating the control board 23. That is, the internal space of each duct 24 and the upper space S1 are partitioned by the upper wall 24b.

In the present embodiment, two ducts 24 adjacent to each other in the X-axis direction share one side wall 24a. The individual ducts 24 may be separated in the X-axis direction without sharing the side wall 24a.

As illustrated in FIGS. 2, 4, and 5, the head holder 22 has a plurality of first vent holes 25 (first ventilation portions) and a plurality of second vent holes 26 (second ventilation portions) as the inlet and outlet of the flow path (duct 24) along each of the head rows L1, L2, L3, L4, L5, L6, L7, and L8. The first vent hole 25 is a hole formed in one side plate 22d to which one end of each duct 24 in the Y-axis direction is connected and penetrates the side plate 22d in the Y-axis direction. The second vent hole 26 is a hole formed in the head holding plate 22a near the other end of each duct 24 in the Y-axis direction and penetrates the head holding plate 22a in the Z-axis direction.

In this manner, a plurality of (eight) flow paths through which air flows along each of the head rows L1, L2, L3, L4, L5, L6, L7, and L8 between the first vent hole 25 and the second vent hole 26 via the duct 24 are formed inside the head holder 22. In the two flow paths adjacent to each other in the X-axis direction, the first vent hole 25 and the second vent hole 26 are disposed opposite to each other (alternately) in the Y-axis direction. Specifically, as illustrated in FIG. 2, in the flow path along the head rows L1, L3, L5, and L7, the first vent hole 25 is formed in the side plate 22d on the +Y direction side, and the second vent hole 26 is formed in the vicinity of the side plate 22d on the -Y direction side. In the flow paths along the head rows L2, L4, L6, and L8, the first vent hole 25 is formed in the side plate 22d on the -Y direction side, and the second vent hole 26 is formed in the vicinity of the side plate 22d on the +Y direction side.

Each of the plurality of second vent holes 26 formed in the head holding plate 22a is provided at a position corresponding to each of the outer suction hole 10f of the conveyance belt 10 in the Y-axis direction. In other words, the second vent holes 26 and the outer suction holes 10f are set in a positional relationship capable of facing each other in the Z-axis direction. Therefore, when the conveyance belt 10 moves in the conveyance direction of the sheet P, the outer suction hole 10f passes below each of the second vent holes 26.

A blower unit 30 as an air blowing unit is provided in a flow path in the duct 24 along each of the head rows L1, L2, L3, L4, L5, L6, L7, and L8. The blower unit 30 is disposed between a plurality of (three) inkjet heads 20 constituting each of the head rows L1, L2, L3, L4, L5, L6, L7, and L8 in the Y-axis direction which is the head arrangement direction. In each of the head rows L1, L2, L3, L4, L5, L6, L7, and L8, in a case where an inkjet head located closest to the +Y direction side is a first inkjet head 20a, an inkjet head located closest to the -Y direction side is a third inkjet head 20c, and an inkjet head located therebetween is a second inkjet head 20b, in the head rows L1, L3, L5, and L7, the blower unit 30 is arranged between the second inkjet head 20b and the third inkjet head 20c, and in the head rows L2, L4, L6, and L8, the blower unit 30 is arranged between the first inkjet head 20a and the second inkjet head 20b. That is, in any of the head rows L1, L2, L3, L4, L5, L6, L7, and L8, the blower unit 30 is disposed at a position adjacent to the second inkjet head 20b at the center in the Y-axis direction.

Note that the configuration of the present embodiment is not limited, and the blower unit 30 may be arranged between the first inkjet head 20a and the second inkjet head 20b in the head rows L1, L3, L5, and L7. In the head rows L2, L4, L6, and L8, the blower unit 30 may be disposed between the second inkjet head 20b and the third inkjet head 20c. Furthermore, in at least some head rows, the blower unit 30 may be arranged between all of the three inkjet heads 20, and two blower units 30 may be provided per one head row. That is, in each of the head rows L1, L2, L3, L4, L5, L6, L7, and L8, the installation position of the blower unit 30 in the head arrangement direction and the number of the blower units 30 can be arbitrarily selected.

Each of the blower units 30 includes a blower fan 31 in a box-shaped housing, and the blower fan 31 is rotationally driven by a blower fan drive motor 32 (FIG. 6) controlled by the control unit 4. When the blower fan 31 rotates, an air flow (airflow) in the Y-axis direction is generated in the duct 24. The traveling direction of the airflow is switched according to the rotation direction of the blower fan 31. When the blower fan 31 is rotated in the first direction, an airflow in the first direction (see FIGS. 2 and 4) traveling from the first vent hole 25 side toward the second vent hole 26 side is formed. When the blower fan 31 is rotated in the second direction opposite to the first direction, an airflow (see FIG. 5) in the second direction traveling from the second vent hole 26 side toward the first vent hole 25 side is formed.

As illustrated in FIGS. 4 and 5, an upper side vent hole 27 (upper side ventilation portion) for communicating the flow path in the duct 24 and the upper space S1 is formed in the upper wall 24b of each duct 24. As illustrated in FIG. 2, each of the upper side vent holes 27 is provided at a position (a position between the blower unit 30 and the second vent hole 26 in the Y-axis direction) on the downstream in the traveling direction of the airflow in the first direction with respect to the blower unit 30 in the flow path along each of the head rows L1, L2, L3, L4, L5, L6, L7, and L8.

The control unit 4 individually monitors the temperatures of the plurality of inkjet heads 20 of the image forming unit 2 via the head temperature detection sensor 28, and controls the operation of the blower unit 30 for each of the head rows L1, L2, L3, L4, L5, L6, L7, and L8 according to the image forming data and the temperature of each inkjet head 20 to perform temperature management. The independent temperature management may be performed by individually operating the blower unit 30 in units of individual head rows, or the common temperature management may be performed by uniformly operating the blower unit 30 in all the head rows. When the heat generation state of the inkjet head 20 for each color varies depending on the difference in the image formed on the sheet P, it is preferable to perform independent temperature management in units of individual head rows.

When cooling the inkjet head 20, the control unit 4 operates the blower fan drive motor 32 to rotate the blower fan 31 in the first direction in the blower unit 30 arranged side by side in the Y-axis direction with the head row to which the inkjet head 20 to be cooled belongs. As illustrated in FIGS. 2 and 4, by the rotation of the blower fan 31 in the first direction, a region from the first vent hole 25 to the blower unit 30 (a region on the upstream of the blower unit 30 in the traveling direction of the airflow in the first direction) is brought into a negative pressure state, and a suction force for allowing outside air (air outside the head holder 22) to flow into the duct 24 from the first vent hole 25 acts. The outside air taken in from the first vent hole 25 passes through the position of the blower unit 30 in the duct 24 and travels toward the second vent hole 26. By the rotation of the blower fan 31 in the first direction, a region from the blower unit 30 to the second vent hole 26 (a region on the downstream of the blower unit 30 in the traveling direction of the airflow in the first direction) is brought into a positive pressure state, and the air passing through the duct 24 is exhausted from the second vent hole 26 to the outside of the head holder 22. The airflow in the first direction in the duct 24 becomes the cooling air, and the cooling air can be applied to each inkjet head 20 in the duct 24 to take heat and cool the inkjet heads (see FIGS. 2 and 4).

When an image is formed on the sheet P by ejecting ink from each inkjet head 20, the control unit 4 operates the blower fan drive motor 32 in the image forming unit 2 to rotate the blower fan 31 in the first direction, and operates the suction fan drive motor 17 in the under-head conveyance unit 3 to rotate the suction fan 16. Further, the conveyance motor 15 is operated to move the conveyance belt 10 in the conveyance direction.

When the suction fan 16 is rotated, in addition to the positions of the plurality of suction holes 10b provided in the conveyance function unit 10c, an airflow directed from the upper side to the lower side of the conveyance surface 10a is generated also at the positions of the plurality of outer suction holes 10f provided in the side region 10d. When the conveyance belt 10 is moved in the conveyance direction, the plurality of outer suction holes 10f sequentially pass below the plurality of second vent holes 26 of the head holder 22. As a result, the cooling air that has cooled each of the inkjet heads 20 and exhausted downward from each of the second vent holes 26 in the image forming unit 2 is sucked to the lower side of the conveyance surface 10a through the outer suction hole 10f (see FIG. 4).

As described above, when an image is formed on the sheet P using the image forming unit 2, the cooling air whose temperature has increased by taking heat from the respective inkjet heads 20 that have generated heat is guided from the respective second vent holes 26 formed in the head holding plate 22a of the head holder 22 to the respective outer suction holes 10f of the under-head conveyance unit 3 disposed below the image forming unit 2 and discharged below the conveyance surface 10a, and the respective inkjet heads 20 can be efficiently cooled. Since the outer suction hole 10f and the second vent hole 26 are arranged in the side region 10d outside the conveyance function unit 10c in the width direction of the conveyance belt 10, even in a state where the sheet P is suctioned and held on the conveyance function unit 10c, each of the outer suction holes 10f is not blocked by the sheet P, and it is possible to reliably exhaust the air from each of the second vent holes 26 toward each of the outer suction holes 10f.

As described above, in the image forming device 1 of the present embodiment, in each head row L1, L2, L3, L4, L5, L6, L7, and L8, the blower unit 30, which is the air blowing unit, is provided between at least some of the plurality of inkjet heads 20 arranged at intervals in the Y-axis direction, which is the head arrangement direction, and air is blown in the head arrangement direction by the operation of the blower unit 30 (rotation of the blower fan 31).

By rotating the blower fan 31 in the first direction, air is taken in from the outside of the head holder 22 through the first vent holes 25, and cooling air traveling in the head arrangement direction is supplied. The control unit 4 adjusts the air volume of the cooling air by setting the rotation speed of the blower fan 31 in the first direction based on the image data to be formed on the sheet P and information such as the temperature of each inkjet head 20 detected by the head temperature detection sensor 28 and the ambient temperature of each inkjet head 20.

By disposing the blower unit 30 at a position close to the inkjet head 20b located on the center side in the Y-axis direction and having a large distance from the first vent hole 25 and the second vent hole 26, it is possible to supply cooling air with a sufficient air volume not only to the inkjet heads 20a and 20c on the outer side in the Y-axis direction close to the first vent hole 25 and the second vent hole 26 but also to the inkjet head 20b on the center side, and it is possible to suppress unevenness in cooling performance when cooling the plurality of inkjet heads 20 constituting each head row L1, L2, L3, L4, L5, L6, L7, and L8. Therefore, efficient cooling according to the temperature distribution of the plurality of inkjet heads 20 can be performed, and the head temperature in the image forming unit 2 can be made uniform.

The plurality of inkjet heads 20 and the blower unit 30 are arranged in the tubular flow path surrounded by the duct 24, so that the cooling air flowed by the rotation of the blower fan 31 is reliably applied to each inkjet head 20 without being dissipated to the outside of the duct 24, and the cooling can be efficiently performed.

The blower unit 30 installed between the plurality of inkjet heads 20 in the head arrangement direction exerts a function of causing the outside air to flow into the head holder 22 through the first vent hole 25 and a function of exhausting the air used for cooling from the second vent hole 26 to the outside of the head holder 22 by rotating the blower fan 31 in the first direction. Therefore, as compared with a configuration in which a fan for supplying air and a fan for discharging air are individually provided outside the head holder 22, the number of blower fans can be reduced and a simple configuration can be obtained.

The cooling effect on each inkjet head 20 in each head row is adjusted by the rotation speed of the blower fan 31 in the first direction, and does not require complicated control to coordinate the operations of the plurality of fans. In addition, the intake and exhaust structure is a simple intake and exhaust structure that takes in and exhausts the outside air through the first vent hole 25 and the second vent hole 26 which are the opening portions formed in the head holder 22, and does not require a complicated operation to open and close the first vent hole 25 and the second vent hole 26. Therefore, there are advantages that the control load of the control unit 4 when cooling each inkjet head 20 in each head row can be low, and the number of movable portions is small and the reliability of the operation is high.

The cooling air that has cooled the inkjet heads 20 in the duct 24 is discharged from the second vent holes 26 to the outside of the duct 24, and is guided to the lower side of the conveyance surface 10a through the outer suction holes 10f using the suction force acting on the conveyance surface 10a by the under-head conveyance unit 3. As a result, excellent cooling performance can be realized without causing the cooling air that has taken heat from each inkjet head 20 and reached a high temperature to stay in the vicinity of the image forming unit 2 or flow backward into the duct 24. In addition, since the exhaust air from the second vent hole 26 is sucked into the outer suction hole 10f arranged outside the conveyance function unit 10c, the cooling effect can be maintained even while the sheet P is suctioned and held by the conveyance function unit 10c of the conveyance belt 10 and conveyed and printed.

The traveling direction of the cooling air (airflow in the first direction) when the blower fan 31 of the blower unit 30 is rotated in the first direction in the head rows L1, L3, L5, and L7 and the traveling direction of the cooling air (airflow in the first direction) when the blower fan 31 of the blower unit 30 is rotated in the first direction in the head rows L2, L4, L6, and L8 are opposite to each other in the Y-axis direction. Since the two head rows adjacent to each other in the X-axis direction are partitioned by the duct 24 (in particular, the side wall 24a), the cooling air traveling in opposite directions along the two adjacent head rows does not interfere with each other, and the inkjet heads 20b configuring the respective head rows can be reliably cooled.

Unlike the illustrated embodiment, it is also possible to adopt a configuration including only a partition wall such as the side wall 24a partitioning between the head rows L1, L2, L3, L4, L5, L6, L7, and L8 and not including the upper wall 24b of the duct 24. That is, the flow path along each of the head rows L1, L2, L3, L4, L5, L6, L7, and L8 may be partially opened instead of being a cylindrical closed space.

Further, unlike the illustrated embodiment, all the first vent holes 25 may be formed in one side plate 22d on the +Y direction side or the -Y direction side, all the second vent holes 26 may be formed in the vicinity of the other side plate 22d, and when the blower fan 31 of the blower unit 30 is rotated in the first direction in the flow paths of all the head rows L1, L2, L3, L4, L5, L6, L7, and L8, the cooling air may travel in parallel in the same direction in the Y-axis direction. In this case, since the cooling air flowing along each of the head rows L1, L2, L3, L4, L5, L6, L7, and L8 is unlikely to interfere with each other, a configuration in which the partition wall (the side wall 24a of the duct 24) partitioning between the head rows is not installed may be adopted.

When the cooling air as the airflow in the first direction flows into each duct 24 by the rotation of the blower fan 31 in the first direction, as illustrated in FIG. 4, a part of the cooling air is supplied to the upper space S1 through the upper side vent hole 27 located on the downstream in the traveling direction of the cooling air with respect to the blower unit 30, and cools the control board 23 as the heating element in the upper space S1. In the flow path in each duct 24, in the region on the downstream in the traveling direction of the cooling air with respect to the blower unit 30 (between the blower unit 30 and the second vent hole 26), a positive pressure state in which the pressure for pushing the cooling air out of each duct 24 is increased in accordance with the rotation of the blower fan 31 in the first direction is established. Therefore, in addition to the exhaust air from the second vent hole 26, a flow of cooling air that passes through the upper side vent hole 27 and proceeds to the upper space S1 is easily formed, and the control board 23 can be efficiently cooled.

An appropriate temperature range at the time of operation is set in the inkjet head 20, and not only the temperature management at the time of cooling in the heat generation state described above but also the temperature management at the time of heating (warm-up) to raise the temperature to the appropriate temperature range is necessary. In particular, the inkjet head 20 disposed on the downstream of the ink supply path in each head row and far from the heater for ink heating, and the inkjet head 20 in an environment far from the heating element such as the control board 23 and close to the outside temperature tend to be slow to rise in a temperature at the time of warm-up, and measures therefor are required. By using the configuration for temperature management of the present embodiment, it is possible to efficiently heat the inkjet heads 20 in the head rows L1, L2, L3, L4, L5, L6, L7, and L8.

At the time of warm-up of the plurality of inkjet heads 20 of the image forming unit 2, the control unit 4 operates the blower fan drive motor 32 to rotate the blower fan 31 in the second direction in the blower unit 30 arranged side by side in the Y-axis direction with the head row to which the inkjet head 20 to be heated belongs. By the rotation of the blower fan 31 in the second direction, a region from the second vent hole 26 to the blower unit 30 (a region on the upstream of the blower unit 30 in the traveling direction of the airflow in the second direction) is brought into a negative pressure state. Then, as illustrated in FIG. 5, a suction force acts from the upper space S1 in the head holder 22 into each duct 24 through the upper side vent hole 27 provided in the region, and air in the upper space S1 warmed by heat generation of the heating element such as the control board 23 is drawn into each duct 24.

As illustrated in FIG. 5, as the blower fan 31 rotates in the second direction, an airflow in the second direction toward the first vent hole 25 is formed in each duct 24. Then, the warm air flowing into each duct 24 from the upper space S1 through the upper side vent hole 27 is supplied to each inkjet head 20 as the heated air that is the airflow in the second direction, and each inkjet head 20 can be heated. The control unit 4 sets the rotation speed of the blower fan 31 in the second direction based on the image data to be formed on the sheet P, the temperature of each inkjet head 20 detected by the head temperature detection sensor 28, the ambient temperature of each inkjet head 20, and the like, and adjusts the air volume of the heated air.

In the head rows L1, L3, L5, and L7, the upper side vent hole 27 is provided above the third inkjet head 20c arranged in the Y-axis direction. The warm air flowing into the duct 24 through the upper side vent hole 27 heats the inkjet head 20c and then is sent to the +Y direction side through the position of the blower unit 30 to sequentially heat the second inkjet head 20b and the first inkjet head 20a.

In the head rows L2, L4, L6, and L8, the upper side vent hole 27 is provided above the first inkjet head 20a arranged in the Y-axis direction. The warm air flowing into the duct 24 through the upper side vent hole 27 heats the inkjet head 20a and then is sent to the -Y direction side through the position of the blower unit 30 to sequentially heat the second inkjet head 20b and the third inkjet head 20c.

In this manner, by rotating the blower fan 31 included in the blower unit 30 in the second direction opposite to that at the time of cooling, the high-temperature air is taken into the duct 24 from the upper space S1 of the head holder 22, and the inkjet heads 20 in the head rows L1, L2, L3, L4, L5, L6, L7, and L8 can be heated. Since the heating is performed using the heat generated by the heating element such as the control board 23 disposed in the upper space S1, a special heat source for heating is not required, and the heating of each inkjet head 20 can be efficiently realized without generating extra energy consumption. The warm air after heating the inkjet head 20 is discharged to the outside of the flow path of each duct 24 through the first vent hole 25.

In the configuration of the present embodiment, all the inkjet heads 20 can be heated in each head row, but in particular, since the temperature of the air immediately after being taken into the duct 24 from the upper side vent hole 27 is high, the inkjet head 20 that is least likely to be warmed (for example, the inkjet head located on the most downstream of the ink supply path) at the time of warm-up is preferably arranged at the position closest to the upper side vent hole 27. For example, taking the head row L1 illustrated in FIG. 5 as an example, since the third inkjet head 20c in the Y-axis direction is most unlikely to be warmed at the time of warm-up, a configuration is applied in which the upper side vent hole 27 is arranged immediately above the inkjet head 20c to increase the heating performance for the inkjet head 20c.

Unlike the illustrated embodiment, the upper side vent hole 27 may be provided not immediately above any one of the inkjet heads 20 but at a position shifted from the inkjet head 20 in the Y-axis direction. For example, in the head rows L1, L3, L5, and L7, the upper side vent hole 27 may be arranged in a range between the third inkjet head 20c and the second vent hole 26. Similarly, in the head rows L2, L4, L6, and L8, the upper side vent hole 27 may be arranged in a range between the first inkjet head 20a and the second vent hole 26.

When the blower fan 31 of the blower unit 30 is rotated in the second direction to heat each inkjet head 20, the control unit 4 preferably performs control to stop the operation of the suction fan 16 of the under-head conveyance unit 3. When the suction fan 16 is operated, a suction force acts from the second vent hole 26 toward the under-head conveyance unit 3, and the warm air taken into each duct 24 from the upper side vent hole 27 is easily exhausted below each duct 24 through the second vent hole 26. By stopping the operation of the suction fan 16, exhaust due to suction from the second vent hole 26 can be suppressed, and warm air in each duct 24 can be caused to travel in the arrangement direction of each inkjet head 20, and the heating performance for each inkjet head 20 can be improved.

A mechanism capable of opening and closing the second vent hole 26 and the outer suction hole 10f may be provided, and the second vent hole 26 and the outer suction hole 10f may be closed when the blower fan 31 is rotated in the second direction to heat each inkjet head 20. According to this configuration, the heating of each inkjet head 20 can be executed while the sheet P is suctioned and held on the conveyance surface 10a to perform conveyance and image formation without stopping the operation of the suction fan 16.

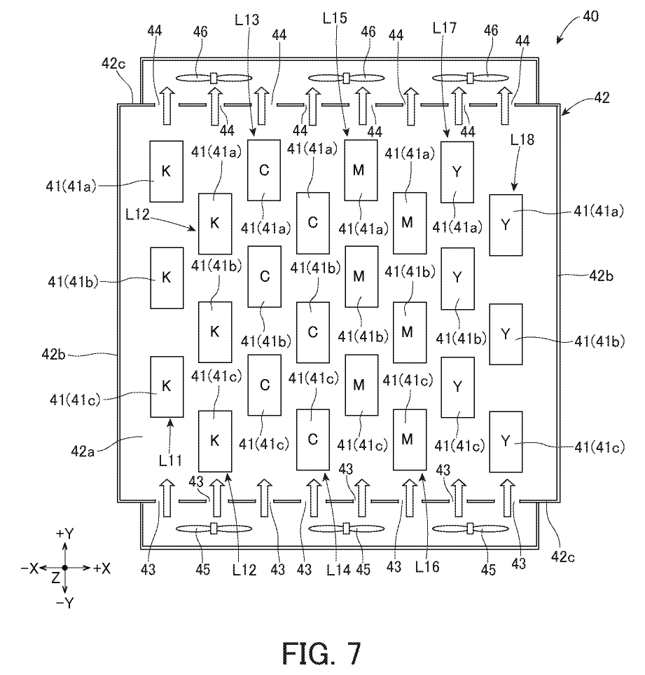

FIG. 7 illustrates an image forming unit 40 of a comparative example having a configuration different from that of the image forming unit 2 of the present embodiment. In the image forming unit 40 of this comparative example, a plurality of inkjet heads 41 are arranged in a staggered pattern in a top view inside a head holder 42. The positional relationship of the plurality of inkjet heads 41 is similar to the positional relationship of the plurality of inkjet heads 20 in the image forming unit 2 of the present embodiment described above, and the three inkjet heads 41 (41a, 41b, and 41c) are arranged at predetermined intervals in the head arrangement direction (Y-axis direction) to constitute one head row, and includes eight head rows L11, L12, L13, L14, L15, L16, L17, and L18 arranged in the X-axis direction. The head holder 42 includes a substantially horizontal head holding plate 42a that holds each of the inkjet heads 41, a pair of side walls 42b and a pair of side walls 42c protruding upward from side edges of the head holding plate 42a. The head holder 42 further includes a top plate (not illustrated) that closes the upper side of the head holding plate 42a.

A plurality of (eight) air supply holes 43 positioned on the extension of the head rows L11, L12, L13, L14, L15, L16, L17, and L18 in the head arrangement direction are formed in one side wall 42c arranged on the -Y direction side of the head holder 42. A plurality of (eight) exhaust holes 44 positioned on the extension of the head rows L11, L12, L13, L14, L15, L16, L17, and L18 in the head arrangement direction are formed in the other side wall 42c arranged on the +Y direction side of the head holder 42.

The image forming unit 40 does not include an air blowing unit inside the head holder 42, and the air supply fan 45 and the exhaust fan 46 are disposed outside the head holder 42. The air supply fan 45 is provided in the vicinity of the air supply hole 43, and the exhaust fan 46 is provided in the vicinity of the exhaust hole 44. When the air supply fan 45 is rotated, an airflow is generated in a direction in which air outside the head holder 42 is sent into the head holder 42 through the air supply hole 43. When the exhaust fan 46 is rotated, an airflow is generated in a direction in which the air inside the head holder 42 is exhausted to the outside of the head holder 42 through the exhaust hole 44. Therefore, by rotating the air supply fan 45 and the exhaust fan 46, a state in which the cooling air flows substantially from the -Y direction side toward the +Y direction side in the head holder 42 is created.

In the image forming unit 40 of the comparative example configured as described above, an experiment of measuring the temperature of each inkjet head 41 when the cooling air is supplied by rotating the air supply fan 45 and the exhaust fan 46 was performed. Then, in each of the head rows L11, L12, L13, L14, L15, L16, L17, and L18, the experimental results showed that the temperature of the inkjet head 41b provided on the center side in the head arrangement direction became significantly higher than the temperature of the inkjet head 41a provided at the position close to the exhaust fan 46 and the temperature of the inkjet head 41c provided at the position close to the air supply fan 45. As a reason for this, it is assumed that in the head holder 42, the flow of air becomes worse at the central portion in the head arrangement direction that is farther from the air supply fan 45 and the exhaust fan 46, and the strength of the cooling air hitting the inkjet head 41b is reduced.

As described above, in the configuration of the image forming unit 40 of the comparative example, the variation in the cooling performance with respect to the plurality of inkjet heads 41 arranged in the head arrangement direction tends to be large, and in particular, the insufficiency in the cooling performance with respect to the inkjet head 41b on the central side in the head arrangement direction becomes a problem.

In the image forming unit 2 of the present embodiment, an experiment of measuring the temperature of each inkjet head 20 when the blower fan 31 of the blower unit 30 is rotated in the first direction and the cooling air is supplied was performed. Then, as compared with the experimental result of the image forming unit 40 of the comparative example, in each head row L1, L2, L3, L4, L5, L6, L7, and L8, the difference in temperature between the three inkjet heads 20 (20a, 20b, and 20c) was small, and a substantially uniform cooling effect could be obtained.

In the image forming unit 2 of the present embodiment, as described above, since the blower unit 30 is disposed at the position close to the inkjet head 20b on the central side in the head arrangement direction (Y-axis direction), a sufficient amount of cooling air can be supplied to the inkjet head 20b, so that the cooling capacity to the inkjet head 20b is unlikely to be insufficient. Furthermore, the inkjet heads 20a and 20c on both sides in the head arrangement direction are arranged on the path through which the cooling air passes the first vent hole 25 and the second vent hole 26, and a sufficient amount of cooling air is supplied. For this reason, the variation in cooling performance with respect to the inkjet heads 20a, 20b, 20c is small, and efficient and excellent cooling can be realized as compared with the configuration of the comparative example.

In the embodiment described above, the outer suction hole 10f of the conveyance belt 10 is formed in a positional relationship corresponding to the second vent hole 26 formed in the head holding plate 22a. However, the present invention is not limited to this configuration, and a configuration in which a plurality number of outer suction holes in the side region 10d of the conveyance belt 10 are formed at the same intervals as the suction holes 10b of the conveyance function unit 10c and the diameter (opening area) is larger than the suction holes 10b of the conveyance function unit 10c can be adopted. In other words, in the side region 10d of the conveyance belt 10, the arrangement density of the outer suction holes and the ratio (opening ratio) of the area in which the outer suction holes are formed may be made larger than those in the illustrated embodiment. With such a configuration, when the conveyance belt 10 moves in the conveyance direction, the period during which the outer suction hole of the conveyance belt 10 faces the second vent hole 26 of the head holding plate 22a becomes long (alternatively, any one of the outer suction holes always faces the second vent hole 26), and it is possible to suppress insufficiency and fluctuation of suction force for sucking exhaust gas from the second vent hole 26 to the suction fan 16 side.

As in the embodiment described above, the temperature adjustment of all the inkjet heads 20 can be efficiently performed by providing the blower unit 30 in all of the plurality of head rows L1, L2, L3, L4, L5, L6, L7, and L8. However, the present invention is not limited to such a configuration, and the blower unit may be provided only in a part of the plurality of head rows. For example, when the temperature of the inkjet head at the time of image formation is particularly high in a specific head row among the plurality of head rows, a blower unit may be arranged in the middle of the head arrangement direction (between the plurality of inkjet heads) in the head row, and the blower unit may not be arranged in the middle of the head arrangement direction in the other head rows.

In the embodiment described above, the duct 24, the first vent hole 25, and the second vent hole 26 are formed in all of the plurality of head rows L1, L2, L3, L4, L5, L6, L7, and L8. However, these components may be provided only in some of the plurality of head rows.

Although the above-described embodiment is applied to an image forming device including an inkjet head that ejects ink as an image forming head, the image forming device of the present disclosure can also be applied to a case of forming an image by a method other than inkjet as long as a plurality of image forming heads are arranged in a line at intervals. For example, even in an image forming head of a method of forming an image by a thermal transfer method, there is a demand for efficiently performing cooling at the time of heat generation and heating at the time of warm-up, and the image forming device of the present disclosure is useful.

Although the present invention has been described with reference to the embodiments and the modifications based on the accompanying drawings, the present invention is not limited to the above-described embodiments and modifications, and various modifications and applications can be made without departing from the scope of the present invention. In the above-described embodiment, the configuration, control, and the like illustrated in the accompanying drawings are not limited thereto, and can be appropriately changed within the scope of exerting the effects of the present invention. In addition, the present invention can be appropriately modified and implemented without departing from the gist of the present invention. Hereinafter, inventions described in the claims as originally filed of the present application will be additionally described.

According to an aspect, an image forming device includes:

a conveyance unit that holds and conveys an image forming medium on a conveyance surface; and

an image forming unit that forms an image on the image forming medium conveyed by the conveyance unit,

in which:

the image forming unit includes a plurality of head rows in each of which a plurality of image forming heads are arranged at intervals in a head arrangement direction perpendicular to a conveyance direction in which the image forming medium is conveyed by the conveyance unit, the plurality of head rows being provided at positions different in the conveyance direction, and

air blowing units that are arranged between at least some of the plurality of image forming heads in the head arrangement direction in at least some of the plurality of head rows and blow air in the head arrangement direction.

According to another aspect, the image forming unit further includes a head holder that holds the plurality of head rows therein,

the head holder includes a first ventilation portion and a second ventilation portion that communicate an internal space of the head holder with the outside on both sides of at least a part of the plurality of head rows in the head arrangement direction, and

in at least the part of the plurality of head rows, an airflow that takes in air outside the head holder from the first ventilation portion and exhausts the air from the second ventilation portion is generated by rotation of a blower fan included in the air blowing units to cool the plurality of image forming heads.

According to another aspect, the conveyance unit includes:

a suction unit that generates a suction force for suctioning and holding the image forming medium on the conveyance surface, and

an outer suction hole that is provided on the conveyance surface, outward of a conveyance function unit that suctions and holds the image forming medium during conveyance in the head arrangement direction, and to which the suction force by the suction unit is applied, and

the second ventilation portion is opened in a direction facing the outer suction hole.

According to another aspect, at least the part of the plurality of head rows includes: a duct that surrounds the plurality of image forming heads and forms a flow path extending in the head arrangement direction,

a heating element different from the plurality of image forming heads in an upper space of the duct inside the head holder,

an upper side ventilation portion that causes an inside of the duct and the upper space to communicate with each other,

a part of an airflow in the duct is supplied from the upper side ventilation portion to the upper space by rotation of the blower fan in a first direction to cool the heating element, and

an airflow that causes air in the upper space to flow into the duct from the upper side ventilation portion and to be exhausted from the first ventilation portion is generated by rotation of the blower fan in a second direction to heat the plurality of image forming heads.

According to another aspect, the conveyance unit includes:

a suction unit that generates a suction force for suctioning and holding the image forming medium on the conveyance surface, and

an outer suction hole that is provided on the conveyance surface, outward of a conveyance function unit that suctions and holds the image forming medium during conveyance in the head arrangement direction, and to which the suction force by the suction unit is applied, and

suction by the suction unit is stopped when the blower fan is rotated in the second direction.

What is claimed is:

1. An image forming device comprising:
a conveyance unit that holds and conveys an image forming medium on a conveyance surface; and
an image forming unit that forms an image on the image forming medium conveyed by the conveyance unit,
wherein
the image forming unit includes a plurality of head rows in each of which a plurality of image forming heads are arranged at intervals in a head arrangement direction perpendicular to a conveyance direction in which the image forming medium is conveyed by the conveyance unit, the plurality of head rows being provided at positions different in the conveyance direction, and
air blowing units that are arranged between at least some of the plurality of image forming heads in the head arrangement direction in at least some of the plurality of head rows and blow air in the head arrangement direction.

2. The image forming device according to claim 1, wherein
the image forming unit further includes a head holder that holds the plurality of head rows therein,
the head holder includes a first ventilation portion and a second ventilation portion that communicate an internal space of the head holder with the outside on both sides of at least a part of the plurality of head rows in the head arrangement direction, and
in at least the part of the plurality of head rows, an airflow that takes in air outside the head holder from the first ventilation portion and exhausts the air from the second ventilation portion is generated by rotation of a blower fan included in the air blowing units to cool the plurality of image forming heads.

3. The image forming device according to claim 2, wherein
the conveyance unit includes:
a suction unit that generates a suction force for suctioning and holding the image forming medium on the conveyance surface, and
an outer suction hole that is provided on the conveyance surface, outward of a conveyance function unit that suctions and holds the image forming medium during conveyance in the head arrangement direction, and to which the suction force by the suction unit is applied, and
the second ventilation portion is opened in a direction facing the outer suction hole.

4. The image forming device according to claim 2, wherein
at least the part of the plurality of head rows includes: a duct that surrounds the plurality of image forming heads and forms a flow path extending in the head arrangement direction,
a heating element different from the plurality of image forming heads in an upper space of the duct inside the head holder,
an upper side ventilation portion that causes an inside of the duct and the upper space to communicate with each other,
a part of an airflow in the duct is supplied from the upper side ventilation portion to the upper space by rotation of the blower fan in a first direction to cool the heating element, and
an airflow that causes air in the upper space to flow into the duct from the upper side ventilation portion and to be exhausted from the first ventilation portion is generated by rotation of the blower fan in a second direction to heat the plurality of image forming heads.

5. The image forming device according to claim 4, wherein
the conveyance unit includes:
a suction unit that generates a suction force for suctioning and holding the image forming medium on the conveyance surface, and
an outer suction hole that is provided on the conveyance surface, outward of a conveyance function unit that suctions and holds the image forming medium during conveyance in the head arrangement direction, and to which the suction force by the suction unit is applied, and
suction by the suction unit is stopped when the blower fan is rotated in the second direction.
